(19) United States
(12) Patent Application Publication
(10) Pub. No.: US 2003/0099162 A1
(43) Pub. Date: May 29, 2003

(54) Snag-free wrist watch

(76) Inventors: Jean Marie Field, New York City, NY (US); Clifford Andrew Scott, New York City, NY (US)

Correspondence Address: WILLIAM COLLARD, COLLARD & ROE, P.C., 1077 NORTHERN BOULEVARD, ROSLYN, NY, 11576, US

(21) Appl. No.: 09/996,450

(22) Filed: Nov. 29, 2001

(51) Int. Cl. A44C 5/00; G04B 37/00

(52) U.S. Cl. 368/281

(57) ABSTRACT

This invention comprises a snag-free wristwatch, having substantially smooth surfaces and flowing contours and free of stems and protrusions, which will eliminate or greatly reduce the potential of state of the art wristwatches to scratch, puncture or tear the skin of persons other than the wearer whom the watch may contact, when worn in normal use and in situations involving possible close contacts as in care giving and sports activities.

### CROSS REFERENCES TO RELATED APPLICATIONS

NONE

### RIGHTS TO INVENTIONS UNDER FEDERALLY SPONSORED RESEARCH AND DEVELOPMENT

NONE

### BACKGROUND OF THE INVENTION

Commonly worn wristwatches often incorporate elements that may snag or tear the exposed skin of persons whom the wearer of the watch may contact. Clothing may be pulled, which can also cause skin damage. The potentially harmful elements of wristwatches may include the watch case itself, bezel, crystal, hinges, stems and stem knobs, horns or lugs for bracelet or strap attachments, attachments, bracelets or straps, ornamentation and insignia, clasps, including buckles and arrangements using hook and loop fabrics of the type generally known as Velcro which can scratch and scrape the skin, and the shape and the bulk of the watch itself.

Although brushing against or being struck by a worn wristwatch may cause skin tears and damage at any time, skin damage is relatively more likely to occur in situations such as the feeding, care and handling of infants and children, assisting and caring for the ill and aged and persons with brittle skin and dermatological problems, and in events involving the possibilities of hard contact, e.g., certain athletic activities. This is an important problem: skin scrapes, tears, punctures and contusions can be highly dangerous where healing processes may be slow or problematic and/or the potentials or likelihoods exist for infection.

In an effort to avoid these dangers, many hospitals and care-giving institutions prohibit the wearing of certain types of jewelry by their caregivers, including wristwatches that may cause injury, and sports referees in, e.g., basketball and wrestling, often will not allow players to wear wristwatches, but these are not complete solutions.

The object of the present invention is to provide a complete wristwatch system, including watch, controls, band, strap or bracelet, connections of the watch thereto and clasp or closures if the band is not continuous, which will eliminate or vastly reduce the potential to snag on the skin and cause the kinds of problems enumerated, in a wristwatch which is functional, durable, easy to manufacture, comfortable to wear, and will be found attractive by a wide range of users.

This invention pertains to the field of endeavor of wristwatches. Works in this category are found in Class 224 Package and article carriers and several of its subclasses, including 160, 170 and 174.

The inventions in this Class include a wide variety of improvements to wristwatch manufacture, bands and bracelets, attachments thereto, extensions, interchangeability of bands and bracelets, assembly, and other features. Most of these inventions, however, retain and some incorporate new features that may scratch or tear skin.

U.S. Pat. No. 4,457,460, Wristwatch strap with protective layer that contacts the wrist, aims to provide skin protection for the user against reactions with allergens in leather watch straps, via a barrier layer for the inner surfaces of the leather straps. The invention does not, however, change the features of the wristwatch as they relate to the potential of the watch to result in damage to the skin of persons other than the wearer.

The Class also includes inventions to protect the wristwatch itself U.S. Pat. No. 4,779,249, Immersible and disposable decorative wristwatch, provides protection for the watch works against the intrusion of sand, water, and dust, by encapsulating the watch works between two strips of thermoplastic material, which also form the watch strap. The encapsulation is accomplished by perimetrically welding the edge seams of the thermoplastic strips. This sealed design precludes the replacement of batteries, which is a standard and desired feature in battery operated watches. U.S. Pat. No. 5,332,135, Apparatus for protecting watches and the like, provides for the encasement of the wristwatch in a system of protective straps which encircle the wearer's wrist and hold and cover the wristwatch to protect it against dirt and dust. While both these inventions evidently meet their intended goals of providing protection against the elements for the watch, their increased bulk and other factors appear to actually increase the possibilities that they will cause injury to persons, other than the wearer, whom the watch may contact.

These inventions in the Class address protection of the wearer from injury by the wristwatch, and protection for the wristwatch itself, but no inventions were found which aimed at or mitigated the potential for the wristwatch to cause harm to persons whom it might contact, other than the wearer.

Applicant's reviews of numerous catalogs of wristwatch offerings and inspections of wristwatch displays in major stores have also failed to reveal any models which address the problems of injuries to persons other than the wearer, whom the watch may come in contact with when worn.

These absences suggest that there is nothing in the prior art and that there have been no commercially successful inventions which solved the problem addressed by the current invention.

### BRIEF SUMMARY OF THE INVENTION

This invention eliminates or greatly reduces the tendency of state of the art wristwatches to snag on and tear or damage the skin of persons other than the wearer. This invention comprises a complete snag-free wristwatch system, encompassing the watch and controls, materials of construction, bracelet, bands or straps, and closures, all designed to avoid the potential in prior art wristwatches to cause skin damage to persons other than wearer.

In one embodiment of this invention, the watch is attached to the band or bracelet, which is formed of one of a variety of flexible materials well known in the art. The watch meets the surface of the band to which it is attached with a smooth joint, nearly undetectable to touch. The watch movement is battery operated and may be solar powered. Pressure sensitive devices are provided for control, including time setting, lighting, and operation of special features. The use of the pressure sensitive control devices which may, for example, be accessed via pressure points located at slight indents in the surface of the wristwatch avoids the need for control stems and protruding buttons that are likely to snag.

Access to the watch is provided for battery replacement. The wristwatch is water resistant and washable to reduce the possibilities of transmission of disease in care giving situations.

In this invention, all dimensional changes in the width and thickness of the wristwatch are made gradually and smoothly, and bulkiness and all protuberances that may snag are avoided. The bracelet or band may be continuous and of a stretchable or slip-on style, sized for various hand and wrist dimensions or provided with closures designed to avoid snagging. Closures may include the well-known bayonet type which is widely used in jewelry, seat belts, and so on, and typically consists of a spring loaded latching device which engages by pushing the two mating pieces together. In jewelry, these types of closures are commonly released by pressing a protruding fin on the bayonet portion of the assembly. In this invention, however, the release pressure points are smoothly incorporated into the band, thus avoiding the use of protruding fins that might cause skin injuries. Other types of snag-free closures may also be used. The bracelet or band may be made of synthetic or natural materials suitably arranged to avoid snagging.

### BRIEF DESCRIPTION OF THE SEVERAL VIEWS OF THE DRAWING

Typical embodiments of the invention, which are not to be interpreted as limiting its scope, are shown schematically in the attached drawings.

FIG. 1 is a perspective view of the invention positioned as if it were worn on the wrist but without the limb showing.

FIG. 2 is a plan view with the wristwatch in an open and flattened position.

FIG. 3 is a side view of FIG. 2.

FIGS. 4 and 5 are cross-sectional views taken across planes A-A¹ and B-B¹ of FIG. 3, respectively.

FIG. 6 is a perspective view of another embodiment of the invention.

FIG. 7 is a plan view with the wristwatch in an open and flattened position.

FIG. 8 is a side view of FIG. 7.

FIG. 9 is a perspective view of another embodiment of the invention.

FIG. 10 is a side view of the wristwatch shown in FIG. 9.

### DETAILED DESCRIPTION OF THE INVENTION

In the attached drawings, like structures will be provided with like reference designations. While a wristwatch is illustrated, the invention may be applied to any limb worn instrument including a computer or medical monitoring device.

Referring to FIG. 1: the invention shown comprises a complete wristwatch in which all components are selected and designed to create a safe and snag-free wristwatch which, when worn, will present only smooth contours to persons other than the wearer whom the watch may contact and thus will not injure them or cause skin tears or damage.

FIG. 1 represents a battery operated or solar powered watch 1, the face or display portion 2 which may be arranged for digital or analog display, and pressure sensitive devices 3 for control of the watch, including setting of time, accessing date information, lighting the watch face, and control of special features. In the embodiment shown, pressing elastically deformable indents in the watch activates the pressure sensitive devices 3.

The watch is set in the band or bracelet 4 which may be fabricated of any of a variety of flexible materials well known in the art, including natural materials and synthetics including polymer-based materials.

Provisions are provided for access 5, to the back or underside of the watch works for battery replacement when needed.

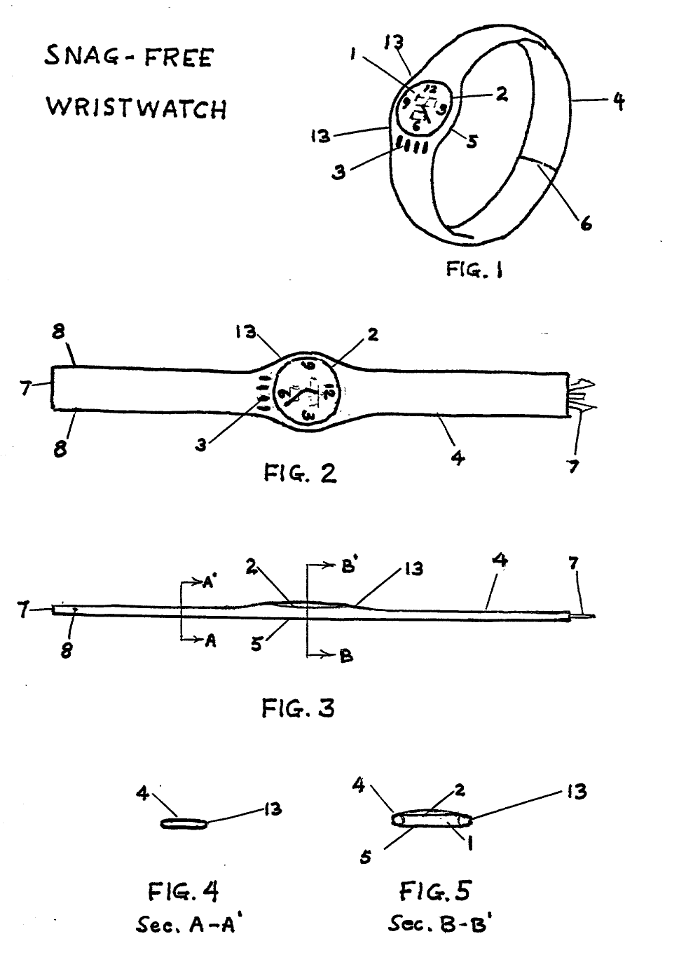

The embodiment of the band or bracelet shown in FIG. 1 shows a clasp 6, which is shown in further detail in FIGS. 2 and 3. A bayonet closure 7 is illustrated, which is released by squeezing the elastically deformable band into which the bayonet is inserted to activate the closure release 8.

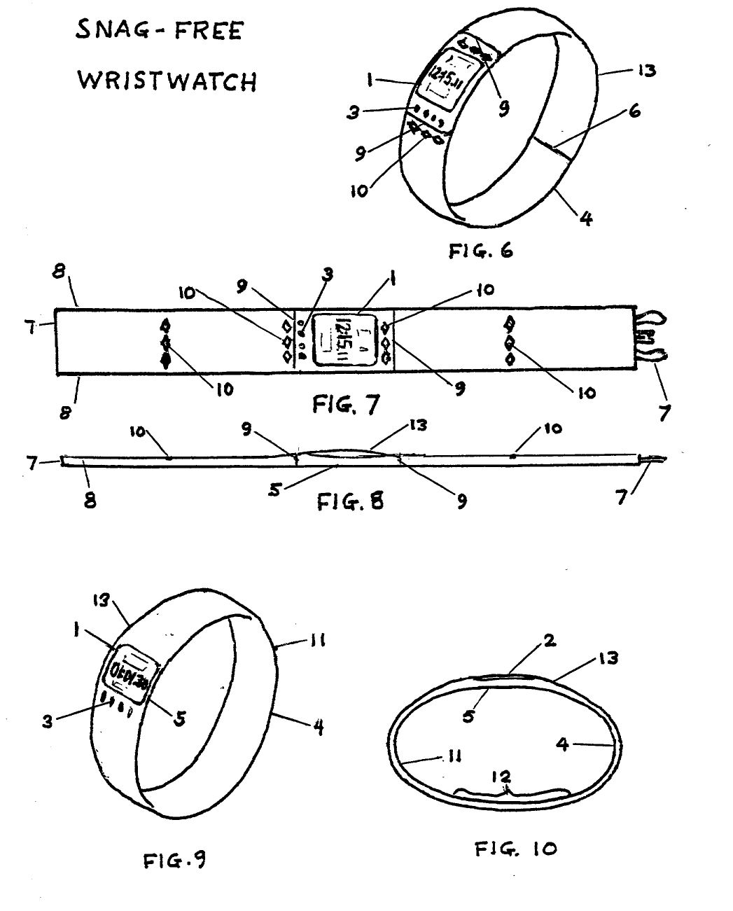

FIGS. 6 through 8 show the watch 1 connected to the band or bracelet by snag-free attachments 9. Jewels and ornamentation 10 are shown, which may include precious gems embedded so as to be visible although below the smooth surface of the wristwatch.

FIGS. 9 depicts the invention with a continuous band or bracelet 11. FIG. 10 shows a band which is stretchable 12.

All of the attached drawings are intended to convey the smoothness of line and snag-free arrangements of the invention. The designation contours 13 is indicated repeatedly in FIGS. 1-10, and is used to indicate and emphasize that all external surfaces of the wristwatch are substantially smooth to the touch and rounded or curved with flowing contours and without excessively high profiles or hard, sharp edges or projections which might catch on and injure the skin of persons whom the wearer of the watch might contact.

Possible embodiments of the invention may include, but are not limited to continuous bracelets, slip on bracelets, stretchable bracelets, sized bracelets, combinations thereof, various types of clasps, and bracelets with linked connections to the watch, and use of the snag-free wristwatch form for multifunctional and special use purposes, including medical monitoring, provided that in all cases the designs result in a snag-free system.

We claim:

1. A snag-free wristwatch having substantially smooth surfaces and flowing contours and free of elements and external stems which might injure the skin of persons whom the wearer of the wristwatch might contact, comprising battery operated watch means for displaying time, pressure sensitive device means for control of said watch, and band means of flexible material for retaining said watch on the limb of wearer, said watch means, said pressure sensitive device means and said band means having flowing contours and surfaces substantially smooth to the touch.

2. The snag-free wristwatch of claim 1 further including snag-free access means for replacing said battery, said access means having substantially smooth and flowing contours when closed.

3. The snag-free wristwatch of claim 1 further including snag-free clasp means having substantially smooth and flowing contours when closed.

4. The snag-free wristwatch of claim 1 further including snag-free clasp means for closure of said band wherein said clasp means are of the bayonet type, well known in the art, having the closure release within and adjacent to elastically deformable portions of said band into which said bayonet is inserted when said clasp is closed, said clasp having substantially smooth and flowing contours when closed.

5. The snag-free wristwatch of claim 1 wherein said wristwatch is water-resistant.

6. The snag-free wristwatch of claim 1 further including snag-free attachment means connecting said watch to said band, with said attachment means having substantially smooth and flowing contours.

7. The snag-free wristwatch of claim 1 wherein said snag-free band is stretchable and has substantially smooth and flowing contours.

8. The snag-free wristwatch of claim 1 wherein said watch is set in said band, with the display and exposed portions of said watch and adjacent portions of said band having substantially smooth and flowing contours.

9. The snag-free wristwatch of claim 1 further including ornamentation, which may include precious gems, incorporated into said watch and said band so as to be visible within the substantially smooth surface and flowing contours of said watch and said band.

10. The snag-free wristwatch of claim 1 wherein said pressure sensitive device means for control of said watch are located below and adjacent to elastically deformable indents on the surface of said watch, said indents being snag-free and below the substantially smooth surface of said watch.

11. The snag-free wristwatch of claim 1 further including multifunction and special use capabilities such as medical monitoring, in the substantially smooth and flowing contours of the form of said wristwatch.

12. A snag-free wristwatch having substantially smooth surfaces and flowing contours and free of elements and external stems which might injure the skin of persons whom the wearer of the wristwatch might contact, comprising battery operated watch means for displaying time, pressure sensitive device means for control of said watch, and band means of flexible polymer-based material for retaining said watch on the limb of wearer, said watch means, said pressure sensitive device means and said band means having flowing contours and surfaces substantially smooth to the touch.

13. The snag-free wristwatch of claim 12 further including snag-free access means for replacing said battery, said access means having substantially smooth and flowing contours when closed.

14. The snag-free wristwatch of claim 12 further including snag-free clasp means having substantially smooth and flowing contours when closed.

15. The snag-free wristwatch of claim 12 further including snag-free clasp means for closure of said band wherein said clasp means are of the bayonet type, well known in the art, having the closure release within and adjacent to elastically deformable portions of said band into which said bayonet is inserted when said clasp is closed, said clasp having substantially smooth and flowing contours when closed.

16. The snag-free wristwatch of claim 12 wherein said wristwatch is water-resistant.

17. The snag-free wristwatch of claim 12 further including snag-free attachment means connecting said watch to said band, with said attachment means having substantially smooth and flowing contours.

18. The snag-free wristwatch of claim 12 wherein said snag-free band is stretchable and has substantially smooth and flowing contours.

19. The snag-free wristwatch of claim 12 wherein said watch is set in said band, with the display and exposed portions of said watch and adjacent portions of said band having substantially smooth and flowing contours.

20. The snag-free wristwatch of claim 12 further including ornamentation, which may include precious gems, incorporated into said watch and said band so as to be visible within the substantially smooth surface and flowing contours of said watch and said band.

21. The snag-free wristwatch of claim 12 wherein said pressure sensitive device means for control of said watch are located below and adjacent to elastically deformable indents on the surface of said watch, said indents being snag-free and below the substantially smooth surface of said watch.

22. The snag-free wristwatch of claim 12 further including multifunction and special use capabilities such as medical monitoring, in the substantially smooth and flowing contours of the form of said wristwatch.
